(19) United States
(12) Patent Application Publication
(10) Pub. No.: US 2003/0100323 A1
(43) Pub. Date: May 29, 2003

(54) Electronic apparatus with a built-in clock function and method of controlling the apparatus

(75) Inventors: Yoshihiro Tajima, Tachikawa-shi (JP); Koichi Kaji, Hidaka-shi (JP)

Correspondence Address: Pillsbury Winthrop LLP, Suite 2800, 725 South Figueroa Street, Los Angeles, CA, 90017-5406, US

(73) Assignee: Kabushiki Kaisha Toshiba, Tokyo (JP)

(21) Appl. No.: 10/225,839

(22) Filed: Aug. 22, 2002

(30) Foreign Application Priority Data
Nov. 28, 2001 (JP) 2001-362751

(51) Int. Cl. H04Q 7/20

(52) U.S. Cl. 455/502; 455/466

(57) ABSTRACT

An electronic apparatus includes a clock device configured to indicate a present date-and-time in a certain time zone. The electronic apparatus includes a unit for managing a scheduled date-and-time in a user's schedule data. A position detector is configured to detect a present position of the electronic apparatus. A unit is also provided for adjusting the present date-and-time indicated by the clock device based on a time difference between a standard time in the certain time zone and a standard time in a time zone corresponding to the present position detected by the position detector. A unit is also provided for adjusting the scheduled date-and-time in the schedule data based on the time difference.

### CROSS-REFERENCE TO RELATED APPLICATIONS

This application is based upon and claims the benefit of priority from prior Japanese Patent Application No. 2001-362751, filed Nov. 28, 2001.

### BACKGROUND OF THE INVENTION

1. Field of the Invention

This invention relates to an electronic apparatus and a method of controlling the electronic apparatus, and more particularly, to a portable electronic apparatus with a built-in clock function of managing the present date and time, and a method of controlling the portable electronic apparatus.

2. Description of the Related Art

With recent advances in information processing technology, various types of information have been digitized and managed by information processing apparatuses, such as personal computers or PDAs (Personal Digital Assistants). One typical example is to manage the user's schedule data. Most of the information processing apparatuses, such as personal computers or PDAs, which are provided with schedule management software, enables the schedule data to be created, edited, and displayed.

Although information-processing apparatuses, such as personal computers or PDAs, have a great many functions, they have the problem of being difficult to operate from a viewpoint of a tool that enables the user to check the schedule easily.

A special schedule managing apparatus for managing a private schedule has been disclosed in Published Japanese Patent No. 2994795. The schedule managing apparatus enables the user to enter a schedule by key operation or voice input and then informs the user of the schedule by alarm sound or voice.

Such a special schedule managing apparatus is simpler in function than such information processing apparatuses as personal computers or PDAs, and has the advantage of being easy to use.

However, the alarm function of the aforementioned special schedule managing apparatus is not interlinked with the schedule data entered in an information processing apparatus, such as a personal computer or a PDA. Thus, the user has to set the date and time for the alarm by, for example, operating the keyboard on the schedule managing apparatus.

Furthermore, for example, when using the schedule managing apparatus during an overseas business trip, the user has to adjust the clock in the schedule managing apparatus and the alarm setting time on the basis of the local time. To change the date and time of each schedule entered as the schedule data, the user has to manually re-edit the contents of each of the entered schedule, which is labor intensive.

### BRIEF SUMMARY OF THE INVENTION

The object of the present invention is to provide an electronic apparatus capable of performing schedule management on the basis of the local time corresponding to the region of the destination and a method of controlling the electronic apparatus.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate an embodiment of the invention, and together with the general description given above and the detailed description of the embodiment given below, serve to explain the principles of the invention.

FIG. 1 shows an outward appearance of an electronic apparatus according to an embodiment of the present invention;

FIG. 2 is a block diagram showing the configuration of the electronic apparatus in the first embodiment;

FIG. 3 shows an example of a clock display screen appearing on the display unit of the electronic apparatus in the embodiment;

FIG. 4 shows an example of an environment-setting screen appearing on the display unit of the electronic apparatus in the embodiment;

FIG. 5 shows an example of a data reception screen appearing on the display unit of the electronic apparatus in the embodiment;

FIG. 6 shows an example of schedule data downloaded and used in the electronic apparatus of the embodiment;

FIG. 7 is a block diagram of a system controller provided in the electronic apparatus of the embodiment;

FIG. 8 is a flowchart to help explain the procedure for the time adjusting operation executed by the electronic apparatus of the embodiment; and

FIG. 9 is a flowchart to help explain the procedure which is for informing the user of the contents of a schedule for the next day using a luminance sensor and which is carried out on the electronic apparatus of the embodiment.

### DETAILED DESCRIPTION OF THE INVENTION

Hereinafter, referring to the accompanying drawings, an embodiment of the present invention will be explained.

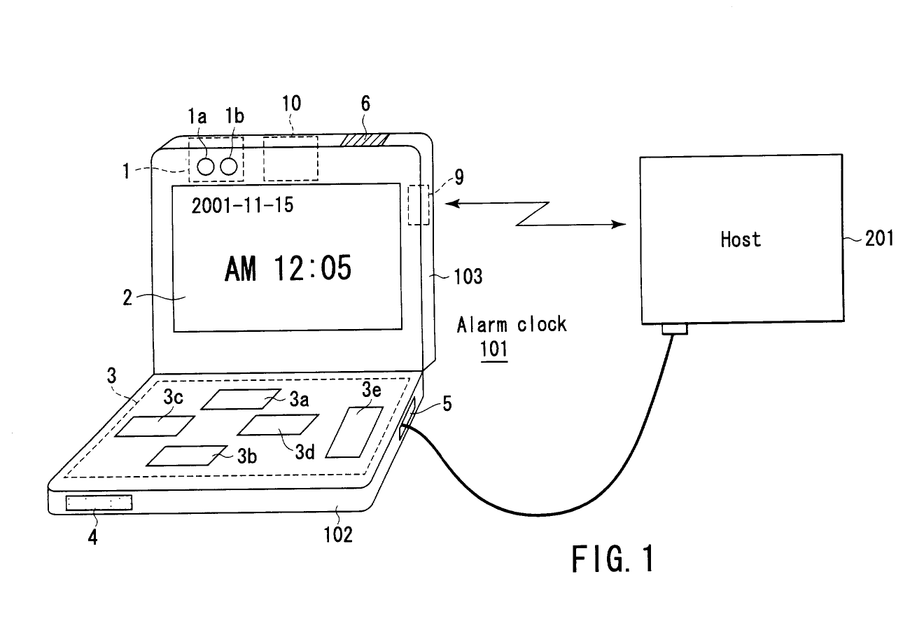

FIG. 1 shows a portable electronic apparatus according to an embodiment of the present invention. The portable electronic apparatus will be explained, taking an alarm clock, an electronic clock device with an alarm function, as an example. An alarm clock 101 is a small electronic apparatus the user can bring with him or her when, for example, traveling or going on a business trip. The alarm clock 101 has not only a clock function of displaying the present date and time and an alarm function of giving an alarm at the preset alarm time but also the function of managing the user's schedule.

As shown in FIG. 1, the alarm clock 101 comprises a body 102 and a display panel 103. In the display panel 103, a display unit 2 composed of a liquid-crystal display is embedded. The display panel 103, which is so provided on the body that it can rotate freely, is set in a closed position where the panel 103 covers the top surface of the body 102, or in an open position where the screen of the display unit 2 is exposed.

On the display panel 103, there are provided not only the display unit 2 but also an indicator 1 for status indication, a luminance sensor 6, a wireless communication device 9, and a GPS (Global Positioning System) unit 10. The indicator 1 for status indication has two status display LEDs, 1a and 1b.

The status display LED 1a represents the state of communication between the alarm clock 101 and a host unit 201. The host unit 201 is, for example, an information processing apparatus, such as a personal computer or a PDA. The communication between the alarm clock 101 and the host unit 201 is carried out to download the user's schedule data managed on the host unit 201 from the host unit 201 to the alarm clock 101. The status display LED 1b represents the communication state of the GPS unit 10.

The luminance sensor 6 is for sensing the luminance around the alarm clock 101. The luminance sensor 6 is used to sense, for example, the fact that the lighting of the room where the alarm clock is placed is turned off. The sensor 6 senses that the user turns off the lighting of the room and goes to bed. The wireless communication device 9 performs wireless communication with the host unit 201. A wireless communication module complying with, for example, the Bluetooth™ standard is used as the wireless communication device 9. The GPS unit 10 is provided as a position-detecting unit for detecting the present position of the alarm clock 101. Receiving external radio waves from several geodetic satellites, the GPS unit 10 senses the position (latitude, longitude) on the earth where the alarm clock resides. The position sensing is used to determine which standard time is used in the region (time zone) where the alarm clock is at present.

At the top surface of the body 102, there is provided a keyboard 3. The keyboard 3 is mainly composed of an input button group used for the environment setting operation of setting the operation environment of the alarm clock 101 on an operation screen appearing on the display unit 2. The input button group includes an up-movement key 3a, a down-movement key 3b, a left-movement key 3c, a right-movement key 3d, and a decision key 3e. On the side face of the body 102, there is provided an external interface 5 for connecting the alarm clock 101 to the host unit 201 via a cable. Moreover, on the front face of the body 102, there is provided a speaker 4. The speaker 4 is used to reproduce alarm sound or audio data.

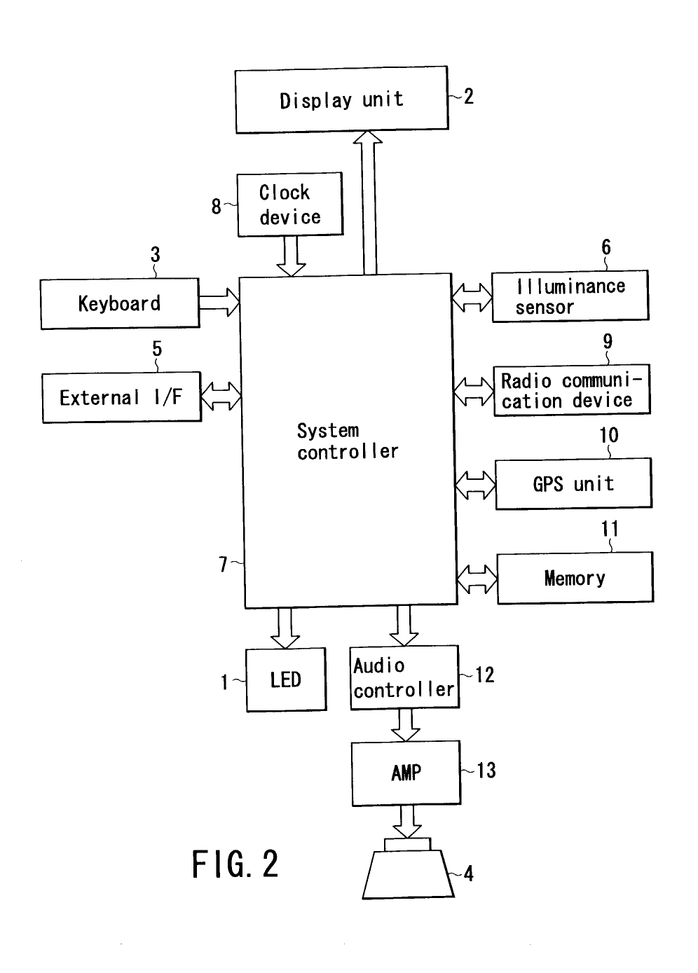

FIG. 2 shows an internal configuration of the alarm clock 101.

The alarm clock 101 comprises not only the display unit 2, keyboard 3, speaker 4, external interface 5, luminance sensor 6, wireless communication device 9, and GPS unit 101, but also a system controller 7, a clock device 8, a memory 11, an audio controller 12, and an audio amplifier (AMP) 13.

The system controller 7, which is provided to control the operation of the alarm clock 101, incorporates a microcomputer. The system controller 7 controls the operation of all of the components excluding the system controller 7.

Specifically, the system controller 7, which is connected to the display unit 2, creates the display data to be displayed on the display unit 2 and transmits the display data to the display unit 2. In addition, the system controller 7, which is also connected to the keyboard 3, moves the cursor on the display screen according to the operations of the aforementioned keys 3a to 3d and stores the operation environment mode currently selected by the cursor into the memory 11 according to the operation of the key 3e. The memory 11, which is composed of, for example, a nonvolatile memory, is used as a work area for the system controller 7. The memory 11 is also used to store information about the operation environment mode and the schedule data.

Furthermore, the system controller 7 communicates with the host unit 201 by using the external interface 5 or wireless communication device 9 and records into the memory 11 the schedule data downloaded from the host unit 201 in the communication. Moreover, the system controller 7, which is also connected to the luminance sensor 6 and GPS unit 10, stores into the memory 11 the luminance information sensed by the luminance sensor 6 and the position information sensed by the GPS unit 10. In addition, the system controller 7, which is also connected to the clock device 8, displays the time and date received from the clock device 8 on the display unit 2.

The clock device 8, which functions as a master clock for the alarm clock 101, indicates the present date and time by using the standard time corresponding to a predetermined specific region (a certain time zone) as a reference time. The user can determine in advance the standard time of which time zone is used as the reference time. The system controller 7 compares the present date and time indicated by the clock device 8 with the scheduled date and time in the schedule data, thereby executing an alarm process of informing the user of the arrival of the alarm time or the scheduled date and time in the schedule data in voice or by alarm sound.

In the voice alarm process of informing the user of the contents of the schedule in voice, the system controller 7 executes a speech synthesizing process of converting the contents of the schedule in the schedule data from the text data into audio data (WAVE data, MIDI data, or the like). The controller 12 converts the audio data from the digital data into analog data. Then, the analog data is output from the speaker 4 via the audio amplifier 13. As a result, the contents of the schedule are read by voice.

When the audio data is previously attached to the schedule data, the audio data may be outputted from the speaker 4 via the audio controller 12 and audio amplifier 13, thereby informing the user of the arrival of the scheduled date and time in the schedule data.

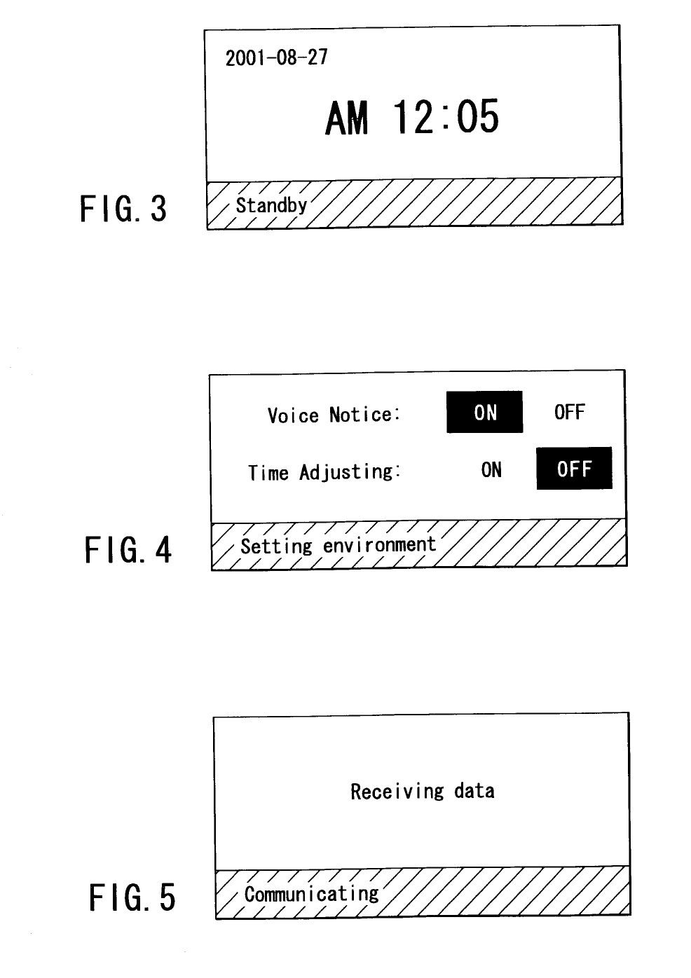

Next, referring to FIGS. 3 to 5, examples of display screens displayed on the display unit 2 will be explained.

FIG. 3 shows a display screen representing the present date and time the clock device 8 is counting. The clock display screen is a default display screen of the alarm clock 101. Normally, the clock display screen is constantly displayed. In the lower part of the clock display screen, state information representing the present state of the alarm clock 101 is displayed. With the clock display screen being displayed, the state information “Standby” means that the alarm clock 101 is on standby.

FIG. 4 shows an example of an operation environment-setting screen for setting the operation environment of the alarm clock 101. On this screen, it is possible to decide whether to use a “voice notice” function, a “time adjusting” function, or various other functions of the alarm clock 101.

The “voice notice” function means a voice alarm function of reading the contents of a schedule indicated by the schedule data when the scheduled date-and-time has been reached. The scheduled date-and-time are the begin date and time or the end date and time related to the schedule. The “time adjusting” function is a function for automatically adjusting the present date and time of the alarm clock 101 on the basis of the standard time in the time zone corresponding to the present position of the clock alarm 101 sensed by the GPS 10. When the “time adjusting” function is set in the enable state (“ON”), not only the present date and time indicated by the clock device 8 are adjusted on the basis of the time difference between the standard time in the time zone corresponding to the present position of the alarm clock 101 sensed by the GPS unit 10 and the standard time in the certain time zone that the clock device 8 is presently used as the reference time, but also the date and time in each schedule in the schedule data stored in the memory 11 are also adjusted.

During the setting of the operation environment, “Setting the environment” appears as the present state information about the alarm clock in the lower part of the screen.

FIG. 5 illustrates a display screen showing that the alarm clock 101 is receiving the schedule data from the host unit 201 through communication between the alarm clock 101 and host unit 201.

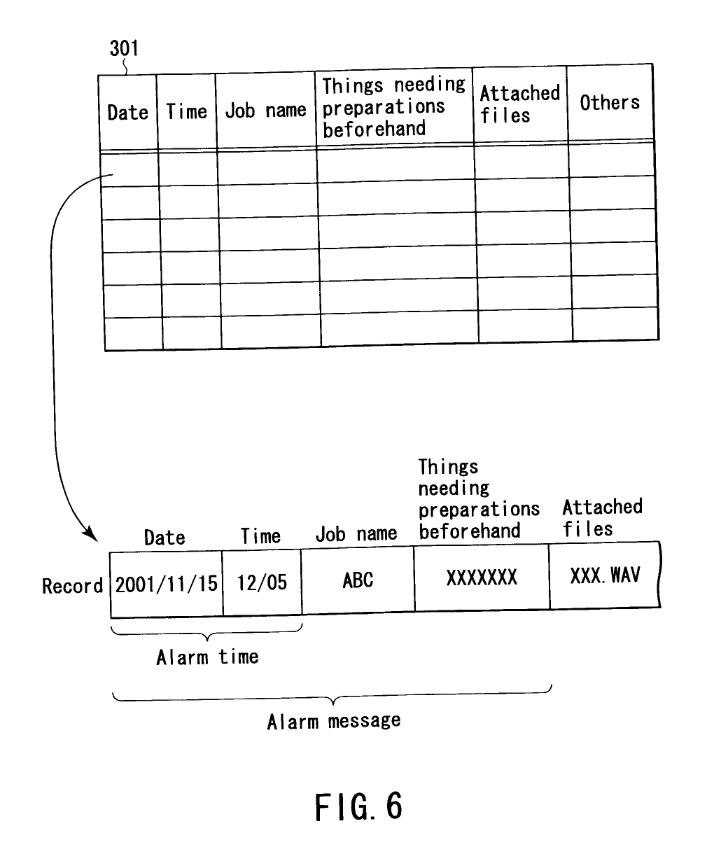

Next, referring to FIG. 6, the operation of managing the schedule data carried out in the alarm clock 101 will be explained.

The alarm clock 101 is capable of taking in the schedule data 301 created and managed on the host unit 201 through communication with the host unit 201 and storing the schedule data 301 into the memory 11. The schedule data 301 stored in the memory 11 can be displayed on the display unit 2 according to the user's instruction. The alarm clock 101 is capable of informing the user of the arrival of the date and time in each of the user's schedules in the schedule data 301 by voice or by alarm sound.

The schedule data 301, which is data for managing the user's schedule, may include the following items for each schedule: “Date,” “Time,” “Job name,” “Things needing preparations beforehand,” “Attached files,” and “Others.” The “Date” and “Time” indicate the year, month, day, and time to be set as the begin date and time or final time limit of the schedule. The “Job name” is information about the title of the schedule or the contents of the schedule. The “Things needing preparations beforehand” is information about things to be prepared beforehand by the night immediately before the scheduled date and time.

To load the schedule data 301 from the host unit 201 into the alarm clock 101, the schedule data 301 is converted into data in a schedule data management format unique to the alarm clock 101 and then stored in the memory 11. In this case, for example, the contents of a schedule (“Date,” “Time,” “Job name,” “Things needing preparations beforehand,” “Attached files,” and “Others”) are managed as one record for each schedule. In the contents of each schedule, the “Date” and “Time” are used as an alarm time to inform the user of the arrival of the scheduled date and time of the schedule. The “Date,” “Time,” “Job name,” and “Things needing preparations beforehand” are used to read the contents of the schedule by the voice alarm function. The alarm time in the contents of each schedule is to be adjusted by the time adjusting function.

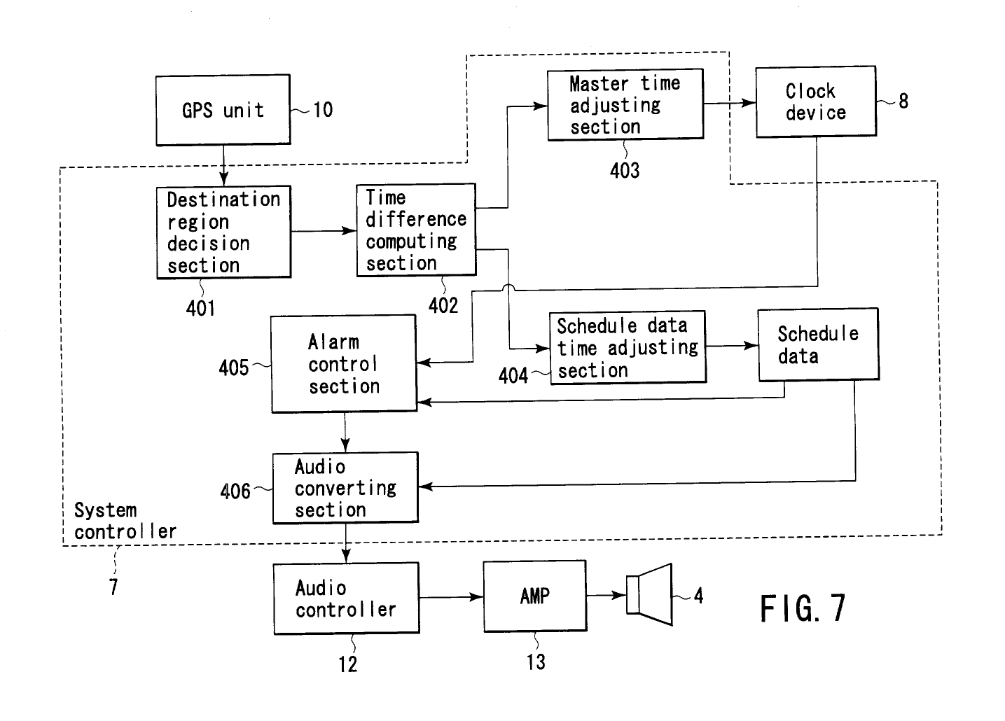

FIG. 7 shows a functional configuration for realizing the time adjusting function and the voice alarm function.

As shown in FIG. 7, the system controller 7 comprises a destination region decision section 401, a time difference computing section 402, a master time adjusting section 403, a schedule data time adjusting section 404, an alarm control section 405, and an audio converting section 406.

From information about the present position of the alarm clock 101 sensed by the GPS unit 10, the destination region decision section 401 determines which standard time is used in the region (time zone) where the alarm clock 101 is present. Specifically, the destination region decision section 401, which stores in advance position information about each region which has its own standard time, determines to which region the present position of the alarm clock 101 sensed by the GPS unit 10 belongs. When the present position of the alarm clock 101 belongs to a time zone other than the time zone whose standard time is currently used as the reference time, the destination region decision section 401 informs the time difference computing section 402 that the region corresponding to the present position of the alarm clock 101 is the destination region. The destination region decision section 401 further notifies the time difference computing section 402 that the alarm clock 101 has moved to a region which has a time difference from the region whose standard time is now being used as the reference time, or that the time zone has been changed.

The time difference computing section 402, which manages the standard times differing from region to region, obtains the standard time corresponding to the destination region and calculates the time difference between the obtained standard time and the standard time in the region now being used as the reference time (plus specific hours and minutes or minus specific hours and minutes). The value of the time difference is sent to the master time adjusting section 403 and schedule data time adjusting section 404. On the basis of the calculated time difference, the master time adjusting section 403 adjusts the values of the present date and time shown by the clock device 8 that is managing the master time of the alarm clock 101, on the basis of the standard time in the destination region. After the master time has been adjusted, the schedule data time adjusting section 404 adjusts the scheduled date-and-time in the schedule data stored in the memory 11 on the basis of the calculated time difference and adjusts the date and time of each schedule on the basis of the standard time in the destination region.

The alarm control section 405, which manages information about the scheduled date and time in the schedule data on the basis of information about the date and time in the clock device 8, has an alarm processing function of informing the user of the arrival of the scheduled date and time on the basis of the present date and time shown by the clock device 8 and date-and-time information in the schedule data. In this case, the alarm control section 405 compares the alarm time of each schedule with the present date and time shown by the clock device 8 and determines whether the scheduled date and time have been reached for each schedule. When an alarm has been set to be given specific minutes before the scheduled time, it is determined whether the scheduled date and time has been reached, taking the preset alarm into account.

Sensing that the schedule whose scheduled date and time managed in the schedule data have been reached, the alarm control section 405 instructs the audio converting section 406 to convert the contents of the schedule (“Date,” “Time,” “Job name,” “Things needing preparation beforehand,” and others) into audio data. The audio converting section 406 performs a speech synthesis process for converting information about the “Date,” “Time,” “Job name,” and “Things needing preparation beforehand” from the text data into audio data and outputs the audio data to the audio controller 12. The audio converting section 406 then causes the audio controller 12 to reproduce an alarm message from the audio data. When audio data is added as an attached file to the contents of the schedule, an alarm message may be reproduced from the audio data.

(Environment Setting Operation)

Next, the environment setting operation of the alarm clock 101 will be explained.

Pressing the decision key 3e on the keyboard 3 for three seconds or longer causes the system controller 7 connected to the decision key 3e to go into the environment setting mode. In this case, the display screen displayed on the display unit 2 proceeds from the clock display screen of FIG. 3 to the environment-setting screen of FIG. 4.

Each environment setting item has two choices, ON and OFF, with the currently selected choice appearing as a white reversed representation. FIG. 4 shows a case where the “voice notice” function is ON (enable) and the “time adjusting” function is OFF (disable). The environment setting item to be set is chosen by moving the cursor vertically using the up-movement key 3a and down-movement key 3b. Moving the cursor by using the left-movement key 3c and right-movement key 3d enables one of “ON” and “OFF” to be chosen. In this state, pressing the decision key 3e for one second determines the setting of “ON” or “OFF.”

Pressing the decision key 3e for three seconds or longer causes the mode to change from the environment setting mode to the normal state, which causes the clock display screen of FIG. 3 to appear.

(Downloading the Schedule Data)

Next, the operation when the schedule data is downloaded from the host unit 201 into the alarm clock 101 will be explained.

The schedule data is downloaded from the host unit 201 into the alarm clock 101 by connecting the external interface 5 of the alarm clock 101 to the host unit 201 with a cable or by connecting the alarm clock 101 to the host unit 201 by wireless with the wireless communication device 9. The LED 1a that indicates the communication state lights green when communication is possible, whereas it lights red when communication is impossible. The transfer of the schedule data from the host unit 201 to the alarm clock 101 is started, the screen of FIG. 5 appears on the display unit 2 under the control of the system controller 7. During communication, the LED 1a blinks.

(Time Adjusting Operation)

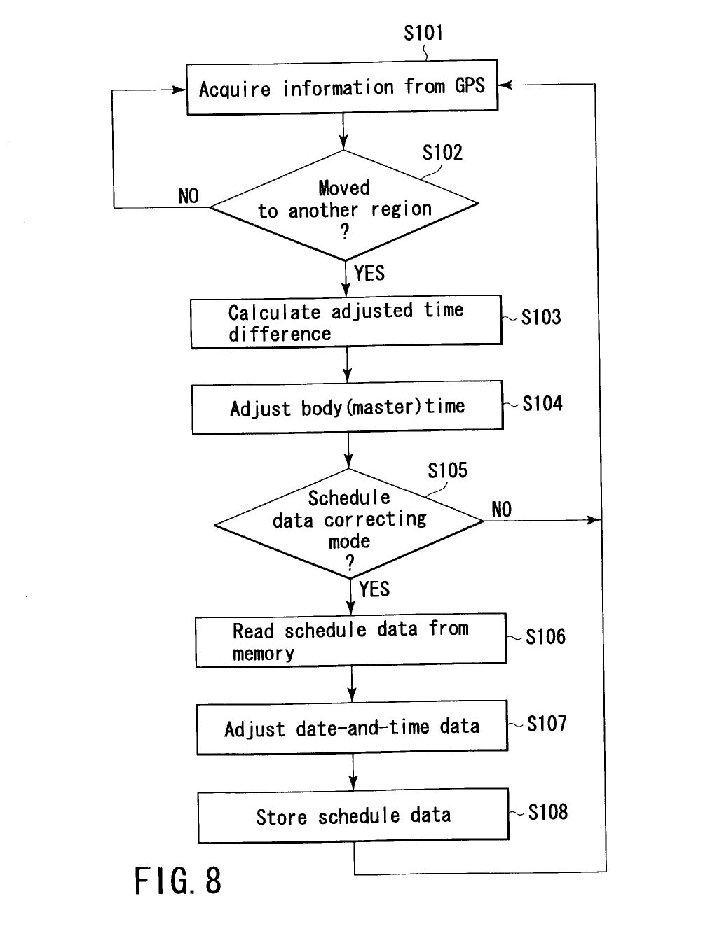

Next, referring to a flowchart in FIG. 8, a concrete procedure for the process of realizing the aforementioned time adjusting function will be explained.

When the “time adjusting” function is ON, the system controller 7 acquires the position information periodically from the GPS unit 10 and determines whether the alarm clock 101 has moved to a region (or a region with a time difference) whose standard time is different from the standard time in a specific region now being used as the reference time by the clock device 8 (steps S101, S102). When it has been sensed that the alarm clock has been moved to a region whose standard time is different from the present one (YES in step S102), the system controller 7 recognizes the standard time of the region corresponding to the present position of the destination on the basis of the position information acquired from the GPS unit 10 and compares the standard time with that of the specific region now being used as the reference time, thereby executing an adjusted time-difference calculating process for determining the time difference to be adjusted (step S103).

On the basis of the time difference obtained from the adjusted time-difference calculating process, the system controller 7 adjusts the body (or master) time, or the present date and time managed by the clock device 8 on the basis of the local time corresponding to the present region to which the alarm clock has moved (step S104). In the adjusting process, the present time of the clock device 8 is advanced or delayed a period of the adjusted time difference (plus specific hours and minutes or minus specific hours and minutes).

Then, the system controller 7 determines whether the schedule data-correcting mode to automatically adjust the date-and-time information in the schedule data is enabled at present (step S105). While the enable/disable of the schedule data correcting mode can be set on the operation environment setting screen as with the “voice notice” function and “time adjusting” function, it may be determined when the “voice notice” function is enabled that the schedule data correcting mode is also enabled.

When the schedule data correcting mode is enabled or “ON” (YES in step S105), the system controller 7 reads the schedule data from the memory 11 and adjusts the date-and-time information (“date” and “time”) of each schedule included in the schedule data to the local time corresponding to the present destination region on the basis of the time difference obtained from the adjusted time-difference calculating process (step S107). In this adjusting process, too, the process of leading or delaying the date and time of the corresponding schedule a period of the adjusted time difference (plus specific hours and minutes or minus specific hours and minutes) is executed. Then, the schedule data after the adjustment of the scheduled date and time are stored in the memory 11 again (step S108).

In step S107, the system controller 7 may adjust the date-and-time information for each of the schedules automatically. It is desirable that identification information that indicates the standard time in which region (time zone) was used to make each schedule should be added to the schedule and the time information should be adjusted only for the schedules made on the basis of the standard time of the specific area before movement. Conversely, on the basis of the identification information added to each schedule, it may be determined whether the schedule is the schedule created on the basis of the standard time of the destination region (that is, a schedule made taking the local time of the destination region into account) and only the time of each of the schedules excluding the schedule made on the basis of the standard time in the destination region may be adjusted. On the basis of the identification information added to each schedule and the sensed destination region, the latter process is realized by determining for each schedule whether the time information can be adjusted or not. On the basis of the identification information added to each schedule and the specific region before movement, the former process is realized by determining for each schedule whether the time information can be adjusted or not.

Furthermore, any rank may be given to each schedule and the time information for only the schedules to which a specific rank has been given may be adjusted. In addition, when the date and time before adjustment are regarded as a reference, the date-and-time information for the schedules whose deadlines have already expired may be prevented from being adjusted.

As described above, adjusting not only the present date and time indicated by the clock device 8 but also the date-and-time information indicated by the schedule data enables the user to view the date and time corresponding to the local time on the clock display screen and check the date and time of each schedule on the basis of the local time without doing any time adjusting work. Therefore, in a case where the user goes to an overseas branch office of the user's company on business and contacts the head office from there, he or she can retrieve the scheduled date and time to make contact on the basis of the local time without doing the work of adjusting the clock and schedule data. For instance, when the user goes to the New York branch office on business from the head office in Tokyo and contacts the head office from there, he or she can check the time to make contact on the basis of the local time. Thereafter, when the user has returned to the head office in Tokyo, the alarm clock 101 adjusts the present date and time indicated by the clock device 8 and the scheduled date and time in the schedule data on the basis of the standard time in Tokyo.

Furthermore, since the arrival of the date and time in the schedule data is notified to the user automatically in voice or by alarm sound, the user can retrieve his or her schedule easily by just carrying the alarm clock 101 with him or her.

(Schedule Notifying Process)

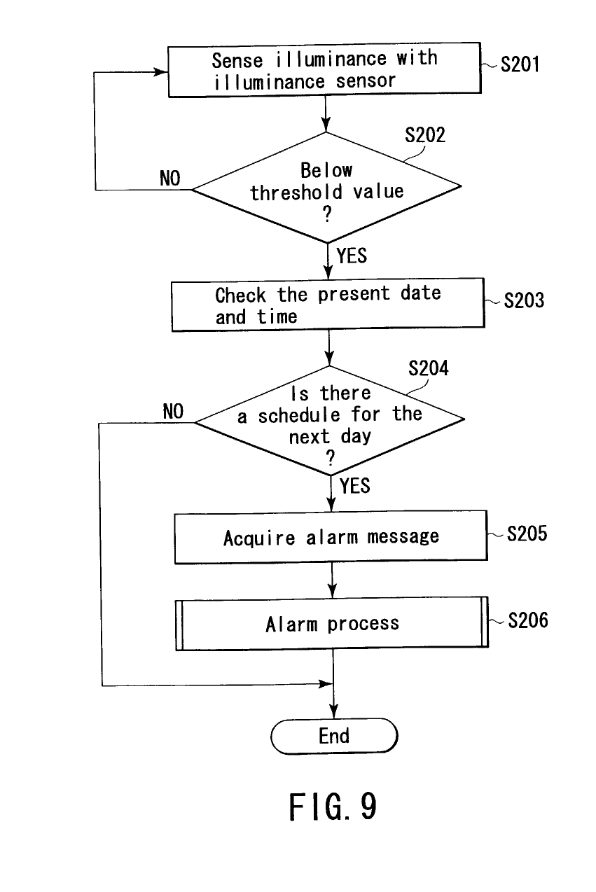

Next, referring to a flowchart in FIG. 9, the operation when the contents of the next day's schedule is notified to the user by using the luminance sensor 6 will be explained.

When the “voice notice” function is enabled and the luminance sensor 6 is enabled, the system controller 7 executes the following processes. The enable/disable of the luminance sensor 6 may be set on the operation environment setting screen as with the “voice notice” function and “time adjusting” function. Alternatively, the enable/disable of the luminance sensor 6 may be switched by the user's key operation.

The system controller 7 checks periodically the luminance around the alarm clock 101 sensed by the luminance sensor 6 and determines whether the luminance drops below a predetermined threshold value (steps S201, S202). The ambient luminance sensed by the luminance sensor 6 and the threshold value are expressed in lux. Although the threshold value is set to a default value, the value may be increased or decreased by the user's key operation. In this case, the threshold value is used to determine whether the user turns off the light to go to bed. Because a lux representation is difficult for the user to understand what brightness of the room corresponds to what lux, it is desirable that such setting items as “darkening” and “lightening” should be displayed on the screen and that the threshold value should be increased or decreased by continuing to press the item “darkening” or “lightening” with the decision key 3e.

When the ambient luminance drops below the threshold value (YES in step S202), the system controller 7 determines that the user has gone to bed and carries out the following process to notify the user of the next day's schedule and what should be prepared by the previous night.

Specifically, the system controller 7 acquires the present date and time from the clock device 8 and recognizes the present date and time (step 203). Then, from the date and time of each schedule in the schedule data stored in the memory 11 and the present date and time, the system controller 7 determines whether the schedule data is for the next day's schedule, thereby searching for the next day's schedule (step S204).

When there is schedule data about the next day's schedule, the system controller 7 takes out the contents of the next day's schedule (“Date,” “Time,” “Job name,” “Things needing preparations beforehand,” and others) as an alarm message from the memory 11 (step S205). Then, the system controller 7 causes the audio converting section 406 to convert the contents of the schedule (“Date,” “Time,” “Job Name,” “Things needing preparations beforehand,” and others) from the text data into audio data and then outputs the audio data to the audio controller 12, which reproduces an alarm message from the audio data (step S206).

As described above, when it is sensed that the lighting of the room where the alarm clock 101 is placed is decreased, the contents of the next day's schedule stored in the memory are read in voice automatically. This configuration enables the user to check the next day's schedule automatically when going to bed. Entering the contents of the next day's schedule together with the contents to be prepared on the previous night into the schedule data enables the user to check not only the contents of the next day's schedule but also the contents to be prepared on the previous night. When the user goes out, putting the alarm clock 101 into his or her pocket, setting the function of the luminance sensor 6 in the disable state easily prevents an erroneous sensing.

As described above, with the embodiment, just loading the schedule data from the host unit 201 into the alarm clock 101 enables a schedule management using the alarm function of the alarm clock 101. Since the time adjusting function enables not only the present date and time of the alarm clock 101 but also the date-and-time information in the schedule data stored in the alarm clock 101 to be adjusted automatically on the basis of the standard time in the destination region, a schedule management can be performed easily on the basis of the local time. Furthermore, the function of reading the contents of a schedule in voice and the function of informing the user of the next day's schedule and the contents to be prepared on the previous night when the user goes to bed enable a very useful schedule management to be realized, particularly when the user goes on a business trip or travels.

This invention is not limited to the above embodiment and may be practiced or embodied in still other ways without departing from the spirit or essential character thereof. For instance, although a GPS is the most suitable as the position-sensing unit, the present position of the alarm clock 101 can be sensed by making use of a position information notifying service by a mobile phone. Furthermore, the time adjusting function related to the clock and schedule data and the voice notice function using the luminance sensor 6 may be provided on, for example, various portable electronic apparatuses, including a wristwatch, a pocket calculator, and a music player.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electronic apparatus, comprising:
a clock device configured to indicate a present date-and-time in a certain time zone;
means for managing a scheduled date-and-time in a user's schedule data;
a position detector to detect a present position of the electronic apparatus;
means for adjusting the present date-and-time indicated by the clock device based on a time difference between a standard time in the certain time zone and a standard time in a time zone corresponding to the present position detected by the position detector; and
means for adjusting the scheduled date-and-time in the schedule data based on the time difference.

2. The electronic apparatus according to claim 1, wherein said means for managing the scheduled date-and-time includes alarm means for notifying the user of arrival of the scheduled date-and-time based on the present date-and-time indicated by said clock device and the scheduled date-and-time in said schedule data.

3. The electronic apparatus according to claim 2, wherein said alarm means includes
means for converting contents of a schedule indicated by said schedule data from text data into audio data, and
means for reproducing the audio data and notifying the user of said contents of the schedule in voice.

4. The electronic apparatus according to claim 1, further including:
a sensor configured to sense luminance around said electronic apparatus, wherein
said means for managing the scheduled date-and-time includes
means for, when the luminance sensed by said sensor drops below a specific luminance, determining whether said schedule data indicates contents of a schedule for a next day based on the present date-and-time indicated by said clock device and the scheduled date-and-time in said schedule data,
means for, when it is determined that said schedule data indicates the contents of the schedule for the next day, converting the contents of the schedule indicated by said schedule data from text data into audio data, and
means for reproducing the audio data and notifying the user of the contents of the schedule for the next day in voice.

5. The electronic apparatus according to claim 1, further including a sensor configured to sense luminance around said electronic apparatus, wherein
said means for managing the scheduled date-and-time includes
means for, when the luminance sensed by said sensor drops below a specific luminance, determining whether said schedule data indicates contents of a schedule for a next day based on the present date-and-time indicated by the clock device and the scheduled date-and-time in said schedule data,
means for, when it is determined that said schedule data indicates the contents of the schedule for the next day, converting the contents of the schedule for the next day and things to be prepared beforehand indicated by said schedule data from text data into audio data, and
means for reproducing the audio data and notifying the user of the contents of the schedule for the next day and the things to be prepared beforehand in voice.

6. The electronic apparatus according to claim 1, further including a sensor configured to sense luminance around said electronic apparatus, wherein
said means for managing the scheduled date-and-time includes
means for, when the luminance sensed by said sensor drops below a specific luminance, determining whether said schedule data indicates contents of a schedule for a next day based on the present date-and-time indicated by the clock device and the scheduled date-and-time in the schedule data, and
means for, when it is determined that said schedule data indicates the contents of the schedule for the next day, reproducing audio data attached to said schedule data.

7. The electronic apparatus according to claim 1, further including means for determining whether to adjust the scheduled date-and-time in said schedule data based on the time zone corresponding to the present position detected by the position detector and identification information attached to said schedule data, said identification information indicating a standard time in a time zone where the scheduled date-and-time in said schedule data was set.

8. A portable electronic clock apparatus which incorporates a clock device configured to indicate a present date-and-time in a certain time zone and to provide an alarm at a set time, said portable electronic clock apparatus comprising:
a display unit to display the present date-and-time indicated by said clock device;
a position detector to detect a present position of said portable electronic clock apparatus by using radio waves;
a communication interface to communicate with an information processing unit;
a storage unit to store a user's schedule data taken in from said information processing unit via said communication interface;
means for adjusting the present date-and-time indicated by the clock device based on a time difference between a standard time in the certain time zone and a standard time in a time zone corresponding to the present position detected by the position detector;
means for adjusting a scheduled date-and-time in the schedule data stored in said storage unit based on the time difference; and
alarm means for notifying the user of arrival of the scheduled date-and-time based on the present date-and-time indicated by the clock device and the scheduled date-and-time in the schedule data.

9. A method of controlling an electronic apparatus with a clock device for managing date-and-time in a certain time zone, comprising:
detecting a present position of the electronic apparatus;
adjusting a present date-and-time indicated by the clock device based on a time difference between a standard time in the certain time zone and a standard time in a time zone corresponding to the detected present position; and
adjusting a scheduled date-and-time in a schedule data stored in said electronic apparatus based on the time difference.

10. The method according to claim 9, further including executing an alarm process of notifying a user of arrival of the scheduled date-and-time based on the present date-and-time indicated by the clock device and the scheduled date-and-time in the schedule data.

11. The method according to claim 10, wherein said executing said alarm process includes
converting contents of a schedule indicated by said schedule data from text data into audio data, and
reproducing the audio data and notifying the user of said contents of the schedule in voice.

12. The method according to claim 9, further including:
sensing luminance around said electronic apparatus;
determining whether said schedule data indicates contents of a schedule for a next day based on the present date-and-time indicated by the clock device and the scheduled date-and-time in the schedule data when the sensed luminance drops below a specific luminance;
converting the contents of the schedule indicated by said schedule data from text data into audio data when it is determined that said schedule data indicates the contents of the schedule for the next day; and
reproducing the audio data and notifying a user of the contents of the schedule for the next day in voice.

13. The method according to claim 9, further including:
sensing luminance around said electronic apparatus;
determining whether said schedule data indicates contents of a schedule for a next day based on the present date-and-time indicated by the clock device and the scheduled date-and-time in the schedule data when the sensed luminance drops below a specific luminance;
converting the contents of the schedule for the next day and things to be prepared beforehand indicated by said schedule data from text data into audio data when it is determined that said schedule data indicates the contents of the schedule for the next day; and
reproducing the audio data and notifying a user of the contents of the schedule for the next day and the things to be prepared beforehand in voice.

14. The method according to claim 9, further including:
sensing luminance around said electronic apparatus;
determining whether said schedule data indicates contents of a schedule for a next day based on the present date-and-time indicated by the clock device and the scheduled date-and-time in the schedule data when the sensed luminance drops below a specific luminance; and
reproducing audio data attached to said schedule data when it is determined that said schedule data indicates the contents of the schedule for the next day.

15. The method according to claim 9, further including determining whether to adjust the scheduled date-and-time in said schedule data based on the time zone corresponding to the present position and identification information attached to said schedule data, said identification information indicating a standard time in a time zone where the scheduled date-and-time in said schedule data was set.

16. An electronic apparatus, comprising:
a clock device configured to indicate a present date-and-time in a certain time zone;
a management device to manage a scheduled date-and-time in a user's schedule data;
a position detector to detect a present position of the electronic apparatus;
an adjustment device to adjust the present date-and-time indicated by the clock device based on a time difference between a standard time in the certain time zone and a standard time in a time zone corresponding to the present position detected by the position detector; and
a schedule adjustment device to adjust the scheduled date-and-time in the schedule data based on the time difference.

17. The electronic apparatus according to claim 16, wherein said management device includes an alarm device to notify the user of arrival of the scheduled date-and-time based on the present date-and-time indicated by said clock device and the scheduled date-and-time in said schedule data.

18. The electronic apparatus according to claim 17, wherein said alarm device includes
a conversion device to convert contents of a schedule indicated by said schedule data from text data into audio data, and
an audio reproduction device to reproduce the audio data and to notify the user of said contents of the schedule in voice.

19. The electronic apparatus according to claim 16, further including a sensor configured to sense luminance around said electronic apparatus, wherein
said management device includes a determination device, when the luminance sensed by said sensor drops below a specific luminance, to determine whether said schedule data indicates contents of a schedule for a next day based on the present date-and-time indicated by the clock device and the scheduled date-and-time in the schedule data, and
an audio reproduction device, when it is determined that said schedule data indicates the contents of the schedule for the next day, to reproduce audio data attached to said schedule data.

20. A portable electronic clock apparatus which incorporates a clock device configured to indicate a present date-and-time in a certain time zone and to provide an alarm at a set time, said portable electronic clock apparatus comprising:
a display unit to display the present date-and-time indicated by said clock device;
a position detector to detect a present position of said portable electronic clock apparatus by using radio waves;
a communication interface to communicate with an information processing unit;
a storage unit to store a user's schedule data taken in from said information processing unit via said communication interface;
an adjustment device to adjust the present date-and-time indicated by the clock device based on a time difference between a standard time in the certain time zone and a standard time in a time zone corresponding to the present position detected by the position detector;
a schedule adjustment device to adjust a scheduled date-and-time in the schedule data stored in said storage unit based on the time difference; and
an alarm device to notify the user of arrival of the scheduled date-and-time based on the present date-and-time indicated by the clock device and the scheduled date-and-time in the schedule data.
